(19) United States
(12) Patent Application Publication
(10) Pub. No.: US 2023/0173802 A1
(43) Pub. Date: Jun. 8, 2023

(54) OVEN SYSTEM FOR HEATING LAMINATED GLASS PANES

(71) Applicant: BENTELER MASCHINENBAU GMBH, Bielefeld (DE)

(72) Inventors: Ralf HUELSEWEDDE, Borgholzhausen (DE); Christoph LINNENBRUEGGER, Bielefeld (DE); Andreas STAUBACH, Leopoldshoehe (DE)

(21) Appl. No.: 18/060,957

(22) Filed: Dec. 1, 2022

(30) Foreign Application Priority Data
Dec. 2, 2021 (DE) 102021131796.7

(51) Int. Cl. B32B 38/00; B32B 17/10; C03B 32/00; C03B 35/16; F27B 9/24; F27D 99/00; F27D 7/04

(52) U.S. Cl. CPC B32B 38/0036; B32B 17/1099; C03B 32/00; C03B 35/16; F27B 9/2407; F27D 7/04; F27D 99/0001; B32B 2310/0454; B32B 2315/08; F27D 2007/045

(57) ABSTRACT

The present invention relates to an oven system 7 for heating laminated glass panes 1, having at least one oven module 8, wherein the laminated glass panes are able to be transported in a horizontal orientation on transport rollers 10 through the oven system 7, and the oven system 7 has an outer box-shaped housing 9, wherein radiation heat sources and convection heat sources are disposed in the housing 9, characterized in that the convection heat sources are configured as elongate tubular nozzles having punctiform outflow openings which are disposed so as to be oriented transversely to the transport direction, wherein in a heat radiator 11 is disposed between two adjacently disposed tubular nozzles 12, and in that a central blower box which supplies the tubular nozzles 12 with heated air is disposed on an end face.

The present invention relates to an oven system for heating laminated glass panes, according to the features in the preamble of claim 1.

Laminated glass panes are known from the prior art. These laminated glass panes are also referred to as laminated safety glass. In order for such a laminated safety glass to be produced, a glass stack composed of at least two panes placed on top of one another and an intervening material is provided. The intervening material is provided in particular as a film and is configured based on plastics material.

In order for this glass stack to henceforce establish a permanent connection, the glass stack is subjected to treatment under temperature and pressure. Consequently, the glass stack is heated such that the intervening film is softened or even fused and on both sides thus connects to the glass panes. It has to be ensured here that the film is homogeneously heated so as to establish a connection across a large area. At the same time, the film must not be excessively heated because this would result in the film combusting or excessively fusing.

To this end, two heating methods are known from the prior art. On the one hand, there is the heating by means of radiation heat. On the other hand, there is heating that takes place by way of convection. In the case of a radiation heat source, the radiation can often not advance up to the films per se such that the film is specifically heated. In order for this to be compensated for, the proportion of convection heat has to be increased. As opposed to radiation heating, in which the film per se absorbs the thermal radiation and is heated as a result, the panes have to be heated in the case of convection heating. The thicker the glass stacks, the slower the transport speed through the oven installation. An increased input of energy is likewise required because the complete glass panes have to be correspondingly heated, in particular homogeneously heated, particularly by means of convection.

An oven which combines both heating options is known from EP 2 431 172 B1, for example.

It is an object of the present invention to provide an oven installation by way of which it is possible to heat laminated glass panes, wherein the oven installation can be operated in a particularly energy-saving manner, and particularly effectively in terms of the heating of the composite glass panes.

The object mentioned above is achieved according to the invention by an oven system according to the features in Claim 1.

Advantageous variants of design embodiments are the subject matter of the dependent claims.

The oven system for heating laminated glass panes has at least one oven module. The laminated glass panes are conveyed in a horizontal orientation on transport rollers through the oven system. The oven system, or the respective oven module, respectively, has an outer box-shaped housing. In the context of the invention, a plurality of oven modules can be disposed in series behind one another. Radiation heat sources and convection heat sources are disposed in the housing.

The oven system is distinguished according to the invention in that the convection heat sources are configured as elongate tubular nozzles having punctiform outflow openings. The tubular nozzles per se are oriented transversely to the transport direction. A heat radiator is disposed between two adjacently disposed tubular nozzles. The heat radiator is likewise configured so as to be elongate or linear, respectively. The heat radiator is also oriented transversely to the transport direction.

The oven system according to the invention is furthermore distinguished in that a central blower box is disposed within the housing on an end face. The tubular nozzles are supplied with heated air by way of the blower box.

A tubular nozzle in the context of the invention has an elongate tubular body, wherein punctiform outflow openings are provided in the tubular body. As a result of the punctiform outflow openings, heated air, consequently convection heat, or a hot airflow, respectively, can then be dispensed in a targeted manner.

In the context of the invention, the tubular nozzles and heat radiators are disposed on the upper side and on the lower side of the glass panes to be transported.

Consequently, a homogeneous thermal input can be incorporated from both sides into a respective glass pane stack, this in turn making possible particularly homogeneous heating, and at the same time also temporally effective heating, up to the film lying between at least two glass panes.

For each tubular nozzle on the upper side, one tubular nozzle is furthermore particularly preferably disposed opposite thereto on the lower side.

For each heat radiator on the upper side, one heat radiator is likewise furthermore preferably disposed opposite thereto on the lower side. As a result, it is possible for the same thermal input to take place at the same point in time on the upper side and the lower side of the glass pane stack in the transport direction. In turn, the homogeneity of the thermal input is also improved as a result.

By virtue of the full capacity not always being required for heating the glass pane stack, tubular nozzles or heat radiators, respectively, may also be omitted in the construction. In this way, more space remains in the interior of the oven system.

The complexity in terms of machinery is reduced according to the invention as a result of the one blower box disposed on an end face. Only one blower per oven module is required in order for all tubular nozzles within the oven module, consequently the tubular nozzles disposed above the glass pane stack and the tubular nozzles disposed below the glass pane stack, to be supplied with heated air. According to the invention it is possible in this way for the one blower box to be disposed laterally in the housing-shaped box of the oven module. As a result of the configuration of elongate tubular nozzles, convection air can nevertheless be dispensed across the entire length of the tubular nozzle, or across the entire area of the oven system, respectively. As a result, a particularly large transport space for the glass panes is effectively provided, without the interior of the oven module in turn being disadvantageously occupied or compromised, respectively, by a multiplicity of blower boxes or the like. Provided in particular to this end is the suction opening or induction opening, respectively, which is disposed in the housing, so that the heated air situated in the oven module is recycled. The induction opening, in terms of the vertical direction, is in particular disposed in an upper third, or an upper region of the oven system, respectively. The heated air rising toward the top is in particular situated in said region. In this way, an energy-efficient utilization of the heat distribution, or of the recycled heated air, respectively, takes place. Furthermore provided in the blower box, in particular in the region of the induction, is a heating installation for temperature-controlling the air to a predefined or predetermined temperature, respectively.

As a result of only one blower box being used, it is not only the complexity in terms of machinery that is reduced, because only one blower has to be operated, but the required installation space is also reduced at the same time, so that the oven modules in terms of the internal and also external dimensions thereof are of a particularly compact construction.

A further advantage according to the invention lies in that the heated air, or airflow, respectively, as a result of the use of the tubular nozzles with exit openings, can flow onto the surface of the laminated glass pane at an angle of at least unequal to 90 degrees. When viewed in the cross section, a plurality of exit openings can be disposed in a radially encircling manner on the tubular nozzle. It is also conceivable for a central exit opening to be disposed in such a manner that the airflow additionally impacts the surface of the glass pane at an angle of 90 degrees. However, as a result of further exit openings, which are radially disposed at an angle deviating from 90 degrees in relation to the surface of the glass pane stack, it is possible to direct the air in a targeted manner, at an angle of unequal to 90 degrees, onto the surface of the glass pane stack. According to the invention, this in turn offers at least two advantages. As a result of a distribution of the hot air, which exits from a tubular nozzle, across an ideally large-area, a relatively large surface of the glass pane can be heated by means of convection during a short time of transport.

A further advantage lies in that the tubular nozzles can be disposed specifically in the lower region of the oven system, between the transport rollers. As a result of the air flowing laterally at an angle out of the tubular nozzle it is thus possible for tubular nozzles in terms of the vertical direction to be disposed almost directly behind a transport roller; it is however ensured at the same time that the surface, or in this case the lower side of the glass pane stack, respectively, is nevertheless heated by air laterally flowing out of the exit opening.

Further advantages, features and properties of the present invention are the subject matter of the description hereunder. Preferred variants of design embodiments are illustrated in schematic figures. The latter serve for readily understanding the invention. In the figures:

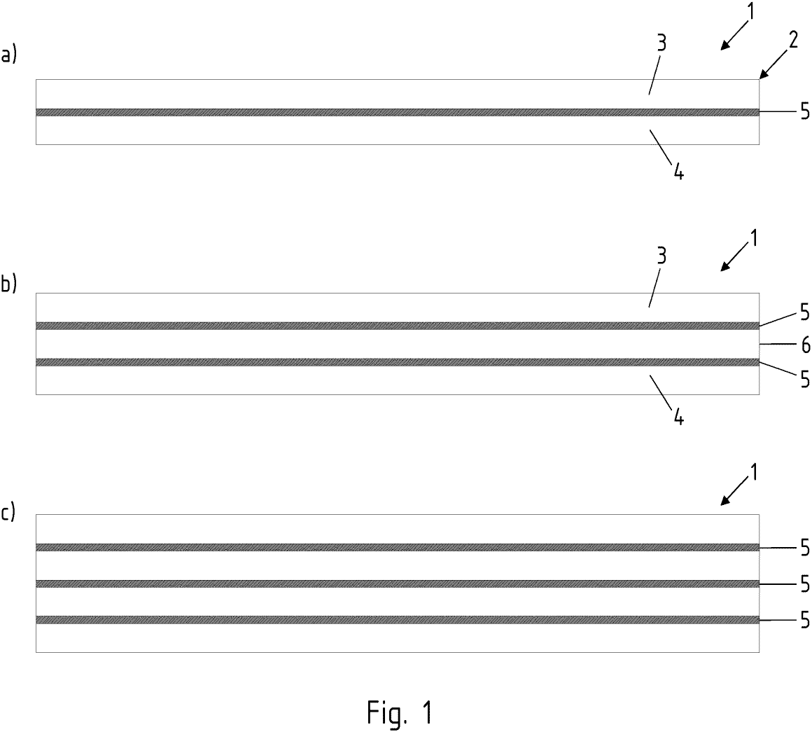

FIGS. 1a to c show different glass pane stacks in a schematic lateral view;

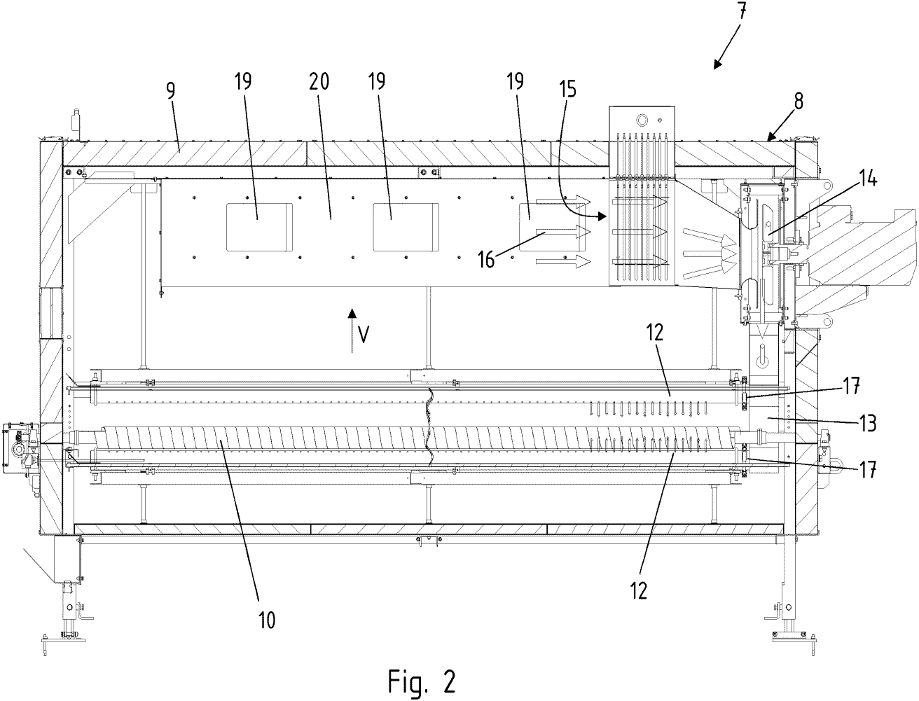

FIG. 2 shows an oven module in a longitudinal sectional view;

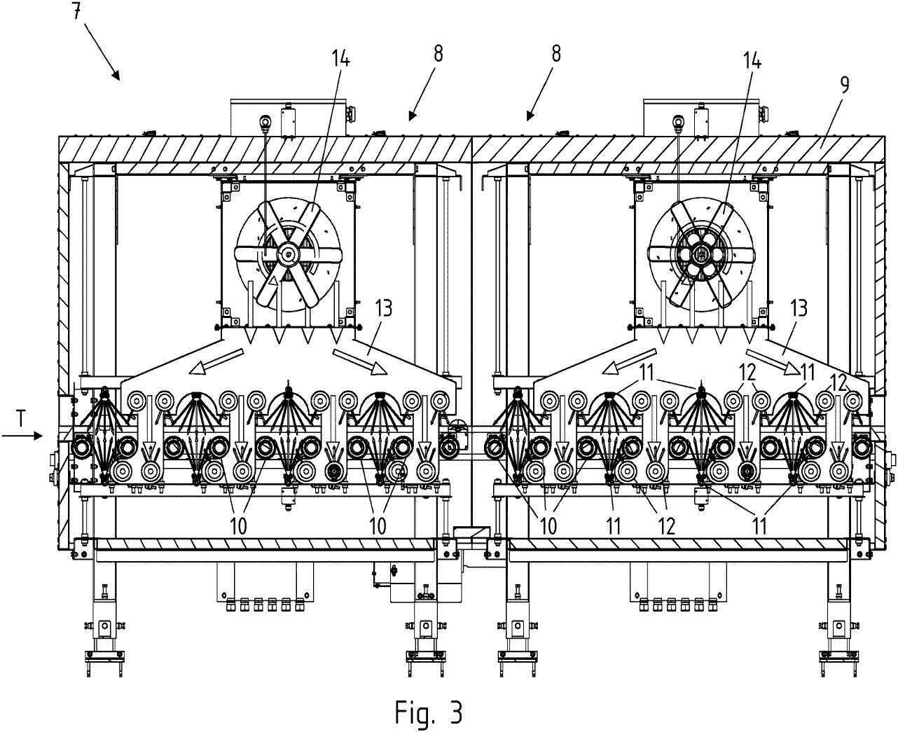

FIG. 3 shows two oven modules which are disposed in series behind one another in a cross-sectional view;

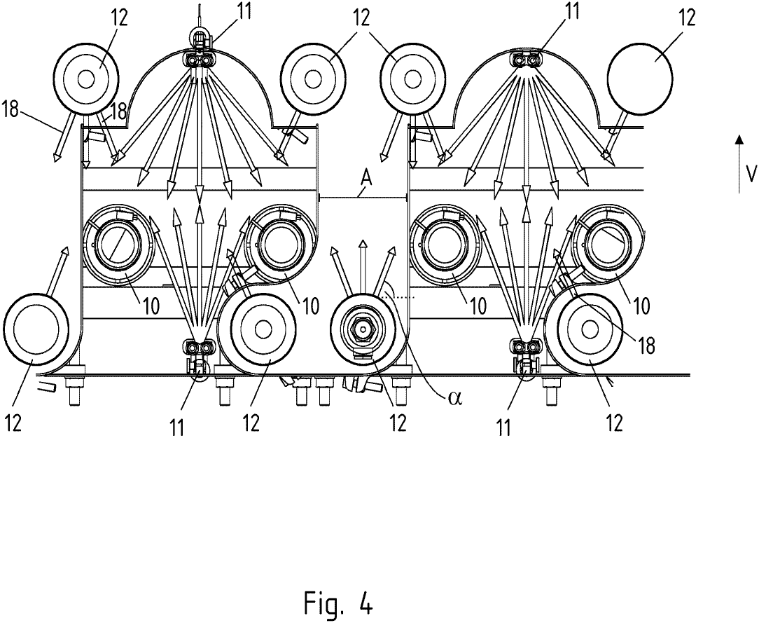

FIG. 4 shows a schematic cross-sectional view pertaining to tubular nozzles and heat radiators, having transport rollers; and

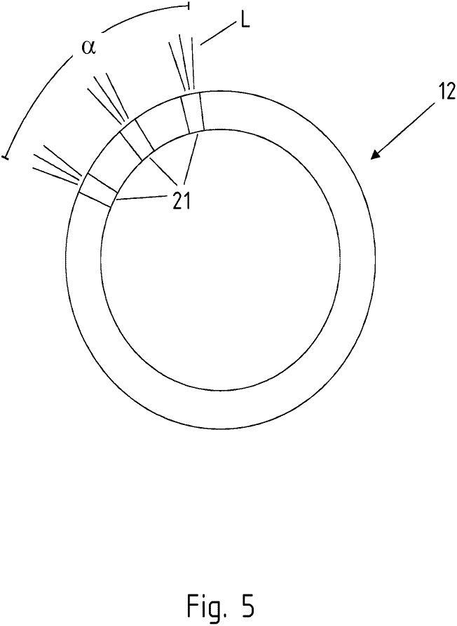

FIG. 5 shows a cross-sectional view through a tubular nozzle.

In the figures, the same reference signs are used for identical or similar components, even when repetition of the description is dispensed with for reasons of simplification.

FIG. 1 a, b, c and d show different laminated glass panes 1 in a cross-sectional view. The laminated glass pane 1 according to FIG. 1 is composed of a glass pane stack 2 consisting of an upper glass pane 3 and a lower glass pane 4 that lie so as to be parallel on top of one another. A film 5 is disposed therebetween. Using the oven system 7 according to the invention it is possible for the film 5, situated between the glass panes, to be heated such that said film is softened and is adhesively bonded to the glass panes.

FIG. 1b likewise shows a laminated glass pane 1. The glass pane stack 2 here, however, is composed of three glass panes, consequently an upper glass pane 3, a lower glass pane 4, and a central glass pane 6. A film 5 is in each case disposed therebetween. According to FIG. 1c, the glass pane stack 2 is composed of four glass panes, each having films 5 disposed therebetween. In particular in the case of the glass panes according to FIGS. 1b and 1c it is consequently more difficult for the films 5 lying further inward to be homogeneously heated on both sides.

To this end, the oven system 7, which in FIG. 2 is illustrated in longitudinal section in an end-on view, provides that at least one oven module 8, which has an external box-shaped housing, is configured. According to the cross-sectional view in FIG. 3, two oven modules 8 are disposed in series behind one another in a transport direction, wherein the box-shaped housing 9 of both oven modules 8 is connected in the center such that an external box-shaped housing 9 is configured.

Transport rollers 10 are disposed in the oven module 8 per se. The transport rollers 10 per se can be actively driven, for example, and in this instance in the transport direction T convey a laminated glass pane 1, or a plurality of successive laminated glass panes 1, respectively, through the oven system 7.

A combination of heat radiators and tubular nozzles are disposed so that the laminated glass panes 1 are now heated within the oven system 7. The heat radiators 11 here generate thermal radiation. The tubular nozzles 12 generate an airflow which then leads to convective heating. A blower box 13 is disposed according to the invention on the end face, in terms of the image plane of FIG. 2, on the right side within the box-shaped housing 9. This blower box 13 is connected to a ventilator 14 which in turn is coupled to an induction opening 15. Inducted through the latter is a heated airflow 16 within the box-shaped housing 9. In terms of the vertical direction V, the induction opening 15 is thus disposed in the upper third such that the heated rising air is inducted and then, by the ventilator 14, is directed into the blower box 13. The blower box 13 per se in turn is coupled to the tubular nozzles by way of a connector on the end face. In this way, tubular nozzles 12 which, in terms of the image plane, are disposed at the top as well as at the bottom in an oven module 8 can be fed centrally with hot convection air by way of a blower box.

Optionally or additionally, an induction duct can be disposed upstream of the induction opening 15. The induction duct 20 per se can be adjusted by way of adjustable openings 20 which are variable in terms of the opening size thereof. As a result of the openings 19 and an induction duct 20 being disposed in an upper part of the housing 9, rising air containing residual heat can in turn be inducted. Reheating can take place while using a minimum amount of supplied external energy.

It can furthermore be readily seen, in particular in a schematic illustration according to FIG. 4, that heated air from the tubular nozzles 12 also exits in each case laterally from a tubular nozzle 12. In this way, a respective tubular nozzle 12 in terms of the vertical direction V can also be disposed behind a transport roller 10. Nevertheless, it is possible that the air, by way of the respective exit opening which is configured in particular as a hole within the tube of the tubular nozzle 12, exits at an angle α unequal to 90 degrees in terms of the glass surface or the transport direction T, respectively, thus obliquely or laterally impacting a glass surface, respectively. The advantage that tubular nozzles 12 can also be disposed in a concealed manner, consequently behind a transport roller 10, is achieved in this way. At the same time, a larger area A is covered or wetted by hot air from the tubular nozzle 12, respectively. This is illustrated in FIG. 4, at the tubular nozzle 12 which is approximately in the center. The dwell time in the oven can thus be shortened, or the transport speed can be increased, respectively, while maintaining homogeneous heating.

FIG. 5 shows a tubular nozzle 12 in the cross-sectional view. Illustrated are the exit openings 21 through which the heated air L can exit the tubular nozzle 12. The exit openings 21 extend across an angular range, or angle α, respectively, of preferably between 10° and 80°, in particular between 20° and 70°. In this way, the heated air can also be applied to the surface of the glass pane stack at an angle.

Reference signs:

| | |
|---|---|
| 1 - | Laminated glass pane |
| 2 - | Glass pane stack |
| 3 - | Upper glass pane |
| 4 - | Lower glass pane |
| 5 - | Film |
| 6 - | Central glass pane |
| 7 - | Oven system |
| 8 - | Oven module |
| 9 - | Housing |
| 10 - | Transport roller |
| 11 - | Heat radiator |
| 12 - | Tubular nozzle |
| 13 - | Blower box |
| 14 - | Ventilator |
| 15 - | Induction opening |
| 16 - | Heated airflow |
| 17 - | End-face connector |
| 18 - | Laterally outflowing air |
| 19 - | Openings |
| 20 - | Induction duct |
| 21 - | Exit openings |
| L - | Airflow |
| T - | Transport direction |
| V - | Vertical direction |
| A - | Area |
| α - | Angle |

1. Oven system for heating laminated glass panes having at least one oven module, wherein the laminated glass panes are able to be transported in a horizontal orientation on transport rollers through the oven system_{,} and the oven system has an outer box-shaped housing, wherein radiation heat sources and convection heat sources are disposed in the housing, wherein the convection heat sources are configured as elongate tubular nozzles having punctiform outflow openings which are disposed so as to be oriented transversely to the transport direction, wherein a heat radiator is disposed between two adjacently disposed tubular nozzles, and in that a central blower box which supplies the tubular nozzles with heated air is disposed on an end face.

2. Oven system according to claim 1, wherein tubular nozzles and heat radiators are disposed on the upper side and the lower side of the glass panes to be transported.

3. Oven system system according to claim 1, wherein for each tubular nozzle on the upper side, one tubular nozzle is disposed opposite thereto on the lower side.

4. Oven system system according to claim 1, wherein for each heat radiator on the upper side, one heat radiator is disposed opposite thereto on the lower side.

5. Oven system system according to claim 1, wherein the blower box is disposed in the housing.

6. Oven system system according to claim 1, wherein the blower box inducts the interior air in the housing, wherein an induction opening in terms of the vertical direction (V) is disposed in an upper part of the housing.

7. Oven system according to claim 1, wherein the blower box is assigned a heating installation.

8. Oven system according to on claim 1, wherein the tubular nozzles also apply heated air laterally at an angle between 10 and 80°, in particular between 20 and 70°, to the surface of the laminated glass panes.

9. Oven system according to claim 1, wherein the tubular nozzles in the vertical direction are disposed behind a transport roller, and in that a radiation heat source is disposed between two transport rollers.
